(19) United States
(12) Patent Application Publication
(10) Pub. No.: US 2011/0079687 A1
(43) Pub. Date: Apr. 7, 2011

(54) Folding a-frame TV stand

(76) Inventor: James E. Grove, Marina Del Rey, CA (US)

(21) Appl. No.: 12/587,093

(22) Filed: Oct. 2, 2009

(51) Int. Cl. F16M 11/38

(52) U.S. Cl. 248/168

(57) ABSTRACT

A folding A-frame TV stand to be detachably connected to a TV mount so that a television connected to the TV mount can be held above the ground. The folding TV stand includes first and second intersecting legs. The first and second legs are pivotally connected to one another by a hinge located at the intersection thereof so that the legs are rotatable at the hinge between an unfolded position, at which the first and second legs are spaced apart to have a “A” shape in order to support the TV mount, and a folded position, at which the legs are moved side-by-side one another to assume a generally flat, space-efficient configuration suitable for transport in a compact shipping container. One of the first and second legs is longer than the other to create a vertical leg extension above the hinge at which the TV stand is detachably connected to the TV mount.

### BACKGROUND OF THE INVENTION

1. Field of the Invention

This invention relates to a folding A-frame TV stand having a pair of legs which are rotatable between an unfolded position, spaced from one another to support a TV mount to which a television is connected so that the television can be held off the ground, and a folded position, lying side-by-side one another to assume a generally flat space-efficient configuration suitable for transport in a compact shipping container.

2. Background Art

Articles of furniture have long been shipped in a fully-assembled condition from a manufacturer to a retailer and then carried off by an end user to a home or office. Consequently, such an article of furniture is characteristically bulky, cumbersome and difficult to transport in a space-efficient manner. That is to say, a fully-assembled article of furniture consumes relatively large shipping space during transport by boat, truck, etc. to a retailer. Similarly, the purchaser/end user may need to have available a specially-sized vehicle should he wish to carry a large article of furniture to his home or office. The inefficient shipment of large articles of furniture between the manufacturer and an end user often results in inconvenience as well as significantly higher transportation costs which are commonly passed through to the purchaser.

By way of a particular example, TV stands which are used to support a television above the ground to be watched by a viewer are typically large and often bulky. It would be desirable to be able to ship a TV stand that is capable of being easily manipulated to assume a space-efficient configuration which enables the stand to be packaged in a compact shipping container so as to reduce shipping costs and facilitate transport.

### SUMMARY OF THE INVENTION

In general terms, a folding A-frame TV stand is disclosed including a pair of intersecting legs to be detachably connected to a TV mount to which a television is connected and supported above the ground. The legs are pivotally connected to one another by means of a hinge having first and second hinge plates and a pivot pin coupled therebetween. The first hinge plate is connected to the top of a first of the pair of legs, and the second hinge plate is connected to the top of the second of the pair of legs, such that the hinge pin lies at the intersection of the pair of legs. The first and second legs are rotatable with the hinge plates around the hinge pin between an unfolded position, at which the legs are spaced apart so as to have an “A” shape, and a folded position, at which the legs are moved side-by-side one another to assume a generally flat space-efficient configuration that is suitable for transport in a compact shipping container without having to disconnect the legs from one another. A base is connected to the bottom of each leg so as to project horizontally outward therefrom and rest upon the ground when the legs are rotated to their unfolded position. A removable shelf pin projects horizontally outward from each of the pair of legs between the top and bottom thereof upon which a shelf is supported.

The pair of legs are detachably connected to the TV mount when the legs of the TV stand are rotated around the hinge pin to their unfolded position. To this end, one of the pair of legs includes an extension that projects vertically upward and above the other leg. A mounting brace projects horizontally outward from the leg extension. A coupling pin stands vertically upward from the mounting brace. The coupling pin is sized so as to be removably received within and surrounded by a coupling sleeve of the TV mount so that the position of the TV mount is adjustable relative to the TV stand. The TV mount to which a television is connected and supported above the ground by the TV stand of this invention is preferably a commercially-available device.

### BRIEF DESCRIPTION OF THE DRAWINGS

FIG. 1 is a perspective view showing a folding A-frame TV stand according to a preferred embodiment of this invention in an unfolded position detachably connected to a TV mount;

FIG. 2 shows the folding TV stand in the unfolded position of FIG. 1 disconnected from the TV mount;

FIG. 3 shows the folding TV stand in a generally flat folded position disconnected from the TV mount;

FIG. 3A is an enlarged detail taken from FIG. 3 showing a hinge by which a pair of legs of the folding TV stand are pivotally connected and rotatable relative to one another;

FIG. 4 shows a coupling pin projecting from a leg extension of one of the pair of legs of the folding TV stand at which the TV stand is detachably connected to the TV mount;

FIG. 5 is a front view showing the folding TV stand in the unfolded position detachably connected to the TV mount; and

FIG. 6 is a front view showing the folding TV stand in the folded position detachably connected to the TV mount.

### DESCRIPTION OF THE PREFERRED EMBODIMENT

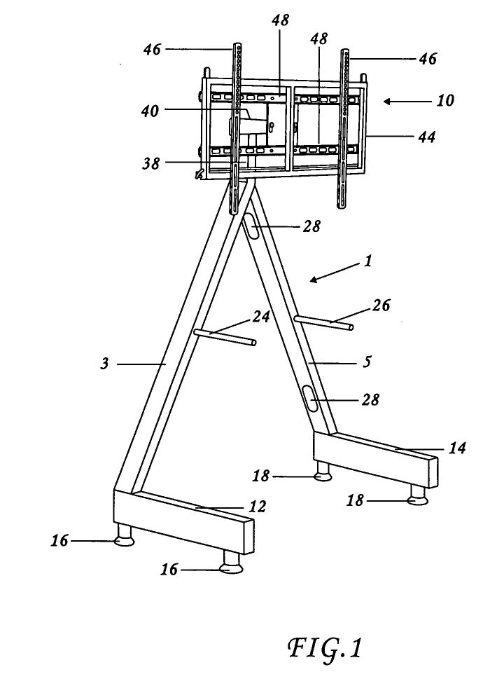

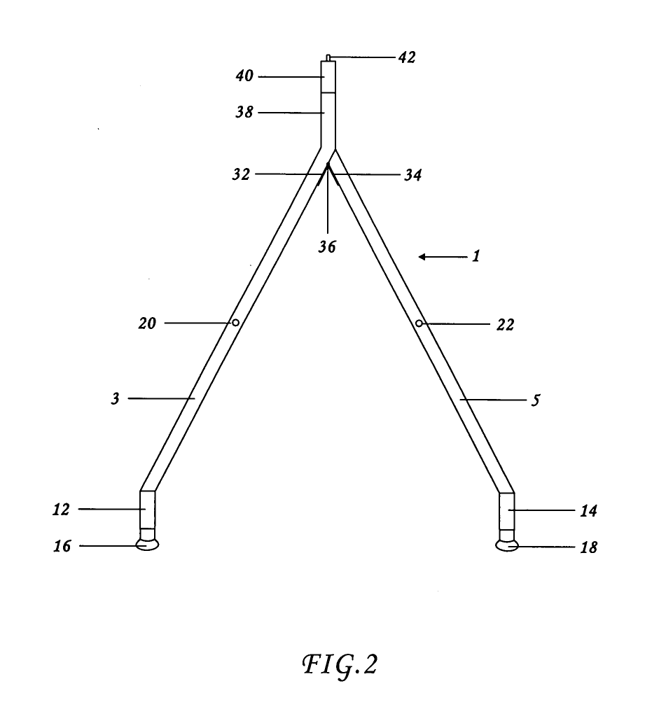

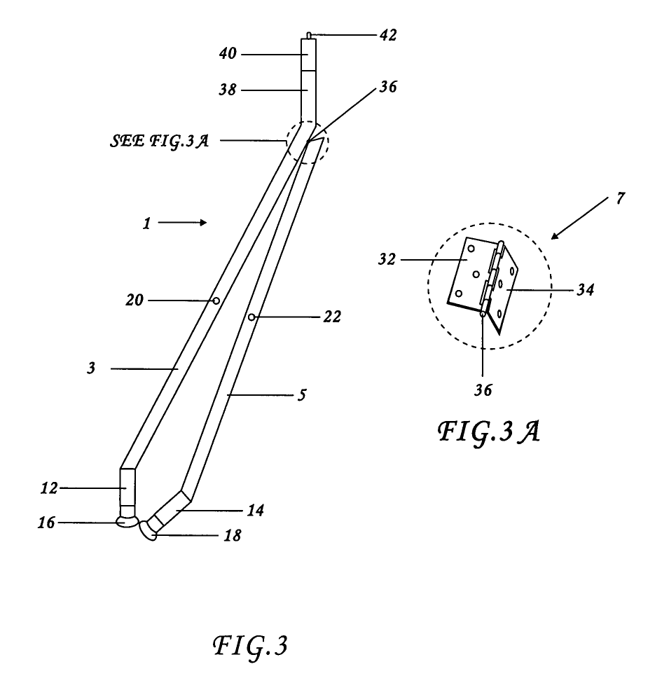

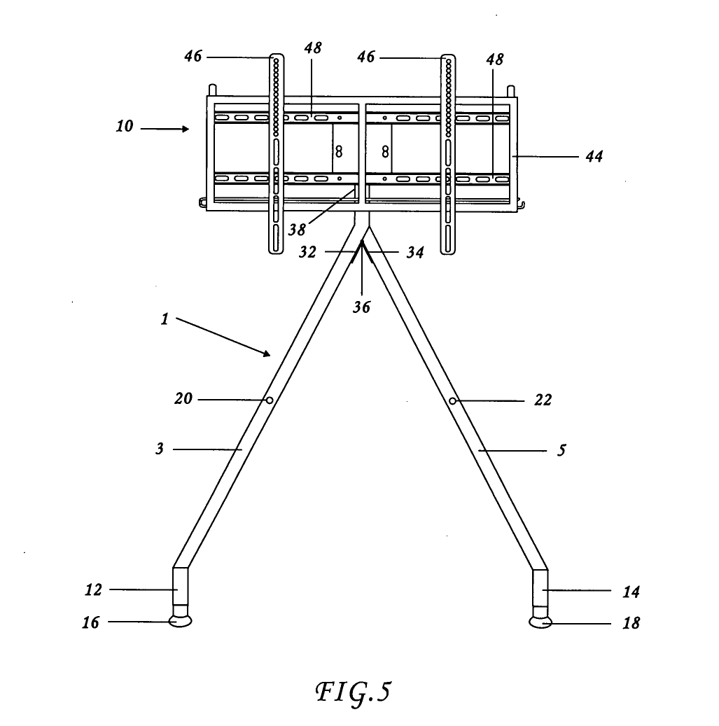

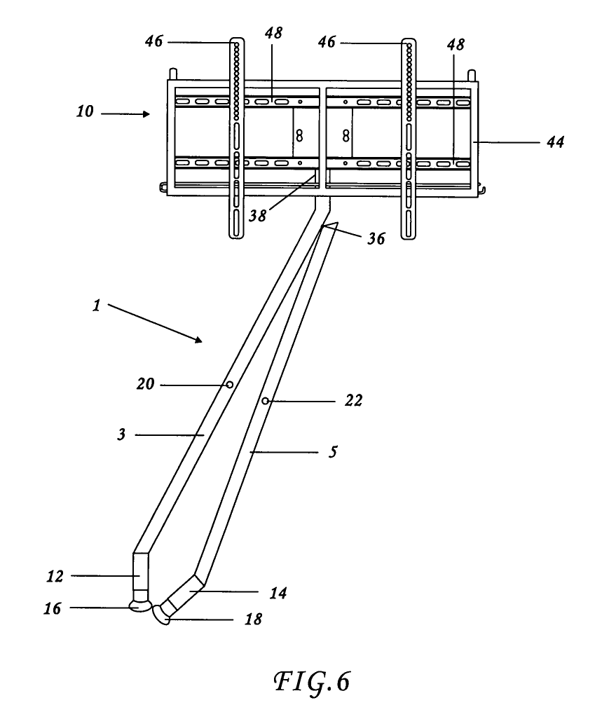

A preferred embodiment for a folding A-frame TV stand 1 is initially described while referring concurrently to FIGS. 1-6 of the drawings. The folding TV stand 1 includes first and second intersecting legs 3 and 5 that are pivotally connected to one another by means of a hinge 7 (best shown in FIG. 3A). By virtue of the foregoing, and as will soon be explained, the legs 3 and 5 are adapted to rotate relative to one another at the hinge 7 between an unfolded position (of FIGS. 2 and 5) and a folded position (of FIGS. 3 and 6). In the unfolded position, the legs 3 and 5 are spaced apart at which to support a TV mount 10 (best shown in FIGS. 1, 5 and 6) atop the TV stand 1. Thus, a television (not shown) attached to the TV mount 10 can be held above the ground by the TV stand 1. In the folded position, and following the disconnection of the TV mount 10 from the TV stand 1, the legs 3 and 5 lie side-by-side one another to assume a generally flat space-efficient configuration that is suited for storage or transport in a compact shipping container without having to disconnect the legs from one another.

A first leg base 12 is connected (e.g., welded) to the bottom of the first leg 3, and a second leg base 14 is connected to the bottom of the second leg 5. The leg bases 12 and 14 project horizontally outward (e.g., approximately 19 inches) from the legs 3 and 5 so as to lie in spaced parallel alignment with one another. A first pair of feet 16 extend downwardly from the first leg base 12 and a second pair of feet 18 extend downwardly from the second leg base 14. With the first and second legs 3 and 5 of the folding TV stand 1 rotated away from one another to their unfolded position, the first and second pairs of feet 16 and 18 rest upon the ground or any similar flat surface.

Each leg 3 and 5 has a pin hole (designated 20 and 22 in FIGS. 2 and 3) formed therein. As is best shown in FIG. 1, elongated shelf pins 24 and 26 are removably located within respective ones of the pin holes 20 and 22. With the first and second legs 3 and 5 of folding TV stand 1 rotated to their unfolded position, the shelf pins 24 and 26 project horizontally outward in spaced parallel alignment with one another from respective ones of the legs 3 and 5. The shelf pins 24 and 26 are located at a suitable elevation lying between the TV mount 10 atop the folding TV stand 1 and the leg bases 12 and 14 at the bottom of stand 1 to support a shelf (not shown).

It is preferable that at least one of the pair of legs (e.g., 5) is hollow. Wire/cable management openings 28 are formed through the top and bottom of the hollow leg 5. The openings 28 facilitate the interconnection of wires and cables between a television to be suspended from the TV stand 1 at the TV mount 10 and an electric power receptacle or any audio/video electronics seated on the shelf which is supported by shelf pins 24 and 26.

Referring particularly now to FIG. 3A, there is shown the hinge 7 by which the top of the first leg 3 of the folding TV stand 1 is pivotally connected to the top of the second leg 5 so that the legs are rotatable apart and together between the unfolded and the folded positions as previously explained. The hinge 7 is conventional and includes a pair of hinge plates 32 and 34 and a hinge pin 36 pivotally connected therebetween. A first plate 32 of the hinge 7 is attached by means of fasteners (not shown) to the inside top of leg 3, and the other plate 34 of hinge 7 is attached to the inside top of leg 5. The hinge pin 36 between hinge plates 32 and 34 lies at the intersection of and between the tops of the pair of legs 3 and 5 to enable the legs to rotate with hinge plates 32 and 34 around the hinge pin 36 between the aforementioned unfolded position of FIGS. 2 and 5 and the folded position of FIGS. 3 and 6. In their unfolded position, the legs 3 and 5 of folding TV stand 1 are spaced from one another and aligned so as to form a relatively wide angle of approximately 45 degrees. In their folded position, the legs are moved (i.e., rotated around the hinge pin 36 of hinge 7) so as to lie side-by-side to form a relatively narrow angle of about 10 degrees. With the legs in the folded position, the feet 16 and 18 at the bottom of the leg bases 12 and 14 are moved into contact with one another. It may be appreciated that when the legs 3 and 5 are rotated to their unfolded position (of FIGS. 2 and 5), the folding TV stand 1 has an “A” shape to maximize the stability thereof.

The top of one of the first and second legs (e.g., 3) has a co-extensive leg extension 38 (best shown in FIGS. 2 and 3). That is to say, the leg 3 is longer than the leg 5. The longer length leg extension 38 turns vertically upward so as to rise above the other leg 5 as well as the hinge 7 at the intersection of legs 3 and 5. A mounting brace 40 projects horizontally outward from the top of the leg extension 38 of leg 3.

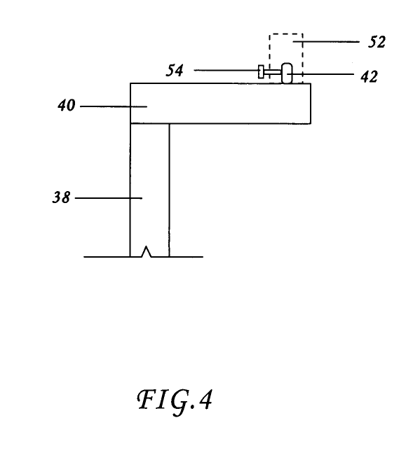

Turning briefly in this regard to FIG. 4, there is shown the horizontal mounting brace 40 projecting from the top of the vertical leg extension 38 so as to lie in front of the legs 3 and 5 and above the leg bases 12 and 14. A coupling pin 42 stands upwardly from the mounting brace 40. The coupling pin 42 is sized to be received within and surrounded by a coupling sleeve (shown in broken lines and designated 52) from the TV mount 10 (of FIGS. 1, 5 and 6). The receipt of the coupling pin 42 by coupling sleeve 52 allows the position of the TV mount to be selectively adjusted (i.e., rotated) relative to the TV stand and the mounting brace 40 thereof to suit the viewing needs of the user. A threaded locking bolt 54 is moved through a correspondingly threaded opening in the coupling sleeve 52 and into engagement with the coupling pin 42 to secure the position of the TV mount once the adjustment has been completed.

The TV mount 10 at the coupling sleeve 10 thereof rests upon the coupling pin 42 (of FIG. 4) so that the TV mount 10 and any television carried by the TV mount 10 are suspended in front of the legs 3 and 5 and held above the leg bases 12 and 14 of the folding TV stand 1. It is to be understood that the particular TV mount 10 that is shown detachably connected to the TV stand 1 forms no part of the present invention, and any one of a variety of commercially-available TV mounts may be substituted for the mount 10. Briefly, however, and by way of example only, the TV mount 10 shown in FIGS. 1, 5 and 6 includes an open rectangular frame 44. A pair of spaced, parallel-aligned TV mounting brackets 46 extend horizontally across the front of the frame 44 to enable the TV mount 10 to be detachably connected to the rear of a television. A pair of spaced, parallel-aligned wall mounting brackets 48 extend vertically across the rear of the frame 44 to enable the TV mount 10 to be secured to a wall, provided that the TV mount is first disconnected from the folding TV stand 1 such that the coupling sleeve 52 (of FIG. 4) is lifted off and separated from the coupling pin 42 at the mounting brace 40 of leg extension 38.

1. A folding TV stand to hold a TV mount to which a television is to be connected off the ground, said folding TV stand comprising first and second intersecting legs pivotally connected to one another and adapted to rotate between an unfolded position, where said legs are spaced apart from and angled relative to one another, and a folded position, where said legs lie side-by-side one another, said TV stand also comprising an extension of said legs at which said TV stand is adapted to be detachably connected to the TV mount.

2. The folding TV stand recited in claim 1, wherein each of said first and second legs has a first end and an opposite end, the first ends of said first and second legs intersecting one another and being rotatable at a hinge located between said first ends, said hinge having first and second hinge plates that are pivotally connected to a hinge pin, the first of said hinge plates connected to the first end of said first leg, the second of said hinge plates connected to the first end of said second leg, and said hinge pin positioned at the intersection of said first and second legs such that said first and second legs rotate around said hinge pin between said unfolded and folded positions.

3. The folding TV stand recited in claim 2, wherein said first and second legs have an “A” shape when said legs are rotated around the hinge pin of said hinge to said unfolded position.

4. The folding TV stand recited in claim 2, wherein said extension is located above said hinge and the intersection of said first and second legs.

5. The folding TV stand recited in claim 4, wherein one of said first and second legs has a length which is longer than the length of the other leg to form said extension above said hinge and the intersection of said first and second legs.

6. The folding TV stand recited in claim 5, wherein there is a coupling pin standing upwardly from and projecting above said extension, said coupling pin adapted to be coupled to the TV mount, whereby said TV stand is detachably connected to the TV mount.

7. The folding TV stand recited in claim 2, further comprising shelf pins projecting from said first and second legs at a location between said first and opposite ends thereof, said shelf pins adapted to support a shelf thereon when said first and second legs are rotated to said unfolded position.

8. The folding TV stand recited in claim 2, further comprising first and second leg bases connected to and extending outwardly from the opposite ends of respective ones of said first and second legs, said first and second leg bases positioned so as to lie along the ground when said first and second legs are rotated to said unfolded position.

9. The folding TV stand recited in claim 8, further comprising a pair of feet connected to each of said first and second leg bases, said pairs of feet lying on the ground when said first and second legs are rotated to said unfolded position.

10. The folding TV stand recited in claim 2, wherein at least one of said first and second legs is hollow, said folding TV stand further comprising a plurality of wire management openings formed in said one hollow leg and lying between said first and opposite ends thereof.
